(19) United States
(12) Patent Application Publication
(10) Pub. No.: US 2013/0280158 A1
(43) Pub. Date: Oct. 24, 2013

(54) METHOD OF PRODUCING COPPER PRECURSOR AND COPPER PRECURSOR PRODUCED BY USING THE SAME

(71) Applicants: Ji Han KWON, Suwon (KR); Kwi Jong Lee, Suwon (KR); Chang Hoon Kim, Suwon (KR); Dong Hoon Kim, Suwon (KR)

(72) Inventors: Ji Han KWON, Suwon (KR); Kwi Jong Lee, Suwon (KR); Chang Hoon Kim, Suwon (KR); Dong Hoon Kim, Suwon (KR)

(73) Assignee: SAMSUNG ELECTRO-MECHANICS CO., LTD.

(21) Appl. No.: 13/618,880

(22) Filed: Sep. 14, 2012

(30) Foreign Application Priority Data
Apr. 20, 2012 (KR) 10-2012-0041519

(51) Int. Cl. C01B 21/20

(52) U.S. Cl. 423/387

(57) ABSTRACT

There is provided a method of producing a copper precursor and a copper precursor produced by using the same. The method of producing a copper precursor includes: preparing an aqueous solution including a copper salt or a hydrate thereof; preparing a mixture by mixing urea (CO(NH₂)₂) with the aqueous solution; and synthesizing the copper precursor by heating the mixture at a temperature of 100 to 120° C.

### CROSS-REFERENCE TO RELATED APPLICATIONS

This application claims the priority of Korean Patent Application No. 10-2012-0041519 filed on Apr. 20, 2012, in the Korean Intellectual Property Office, the disclosure of which is incorporated herein by reference.

### BACKGROUND OF THE INVENTION

1. Field of the Invention

The present invention relates to a method of producing a copper precursor and a copper precursor produced by using the same, and more particularly, to a method of producing a copper precursor and a copper precursor produced by using the same, capable of producing the copper precursor without an intermediate and synthesizing the copper precursor at a low temperature.

2. Description of the Related Art

Since copper (Cu) has a specific resistance on the same level as that of silver (Ag) and has a low cost approximately one hundredth that of silver (Ag), it has been currently used for electrical wiring in a majority of electrical components.

Copper (Cu) has been used as a powder in industry in many instances, and a copper precursor for preparing the copper powder has been produced by various methods.

A specific copper precursor may be naturally oxidized in the air or be oxidized at the time of a heat treatment.

In the case of the copper precursor using a nitrate form of the copper, since it has a deliquescent property in which it absorbs moisture from the air by itself, it is difficult to store and use the copper precursor.

In addition, the related art document below discloses a method of producing a copper hydroxide precipitate by adding sodium hydroxide to an aqueous copper sulfate solution. However, in the case of using this method, an intermediate may be required, and an organic material content may be increased in a precursor material.

### RELATED ART DOCUMENT

Korean Patent Laid-Open Publication No. 2010-0091532

### SUMMARY OF THE INVENTION

An aspect of the present invention provides a method of producing a copper precursor and a copper precursor produced by using the same, and more specifically, provides a method of producing a copper precursor and a copper precursor produced by using the same, capable of producing the copper precursor without an intermediate and synthesizing the precursor at low temperature.

According to an aspect of the present invention, there is provided a method of producing a copper precursor, the method including: preparing an aqueous solution including a copper salt or a hydrate thereof; preparing a mixture by mixing urea (CO(NH₂)₂) with the aqueous solution; and synthesizing the copper precursor by heating the mixture at a temperature of 100 to 120° C.

The copper salt or the hydrate thereof may be cupric nitrate trihydrate (Cu(NO₃)₂.3H₂O).

The preparing of the aqueous solution may be performed by dissolving the copper salt or the hydrate thereof in water at room temperature.

The preparing of the mixture may be performed at the room temperature.

The method may further include drying the copper precursor at 60 to 80° C. after the synthesizing of the copper precursor.

The copper precursor may be Cu₂(NO₂) (OH)₃.

The copper precursor may have a carbon (C) content of 0.3 wt % as a detection reference value, or less.

The preparing of the mixture may be performed by mixing 12 to 200 parts by weight of urea (CO(NH₂)₂) with the aqueous solution based on 100 parts by weight of the copper salt or the hydrate thereof.

According to another aspect of the present invention, there is provided a copper precursor produced by mixing urea (CO(NH₂)₂), with an aqueous solution including a copper salt or a hydrate thereof, the copper precursor having a carbon (C) content of 0.3 wt % as a detection reference value, or less.

The copper salt or the hydrate thereof may be cupric nitrate trihydrate (Cu(NO₃)₃.3H₂O).

The copper precursor may be Cu₂(NO₃) (OH)₃.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a process flow chart schematically illustrating a method of producing a copper precursor according to an embodiment of the present invention;

FIG. 2A and FIG. 2B are scanning electron microscope (SEM) images of the copper precursor according to the embodiment of the present invention; and

FIG. 3 is a graph illustrating input amount vs. production amount according to the embodiment of the present invention.

### DETAILED DESCRIPTION OF THE EMBODIMENTS

Hereinafter, embodiments of the present invention will be described in detail with reference to the accompanying drawings so that those skilled in the art may easily understand the spirit of the invention and implement the present invention.

The invention may, however, be embodied in many different forms and should not be construed as being limited to the embodiments set forth herein.

Rather, these embodiments are provided so that this disclosure will be thorough and complete, and will fully convey the concept of the invention to those skilled in the art.

In the drawings, the shapes and dimensions of elements may be exaggerated for clarity, and the same reference numerals will be used throughout to designate the same or like components.

In addition, like reference numerals denote parts performing similar functions and actions throughout the drawings.

In addition, unless explicitly described otherwise, “comprising” any components will be understood to imply the inclusion of other components but not the exclusion of any other components.

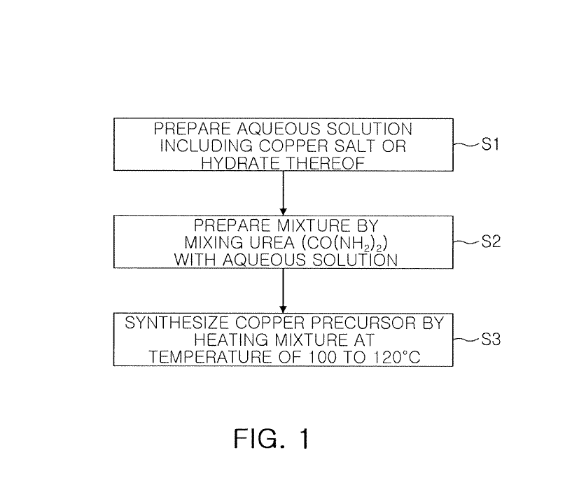

FIG. 1 is a process flow chart schematically illustrating a method of producing a copper precursor according to an embodiment of the present invention.

Referring to FIG. 1, a method of producing the copper precursor according to the embodiment of the present invention may include preparing an aqueous solution including a copper salt or a hydrate thereof; preparing a mixture by mixing urea (CO(NH₂)₂) with the aqueous solution; and synthesizing the copper precursor by heating the mixture at a temperature of 100 to 120° C.

According to the embodiment of the present invention, the method of producing the copper precursor may include, first, preparing the aqueous solution including the copper salt or the hydrate thereof.

The copper salt or the hydrate thereof may be cupric nitrate trihydrate (Cu(NO₃)₂.3H₂O), but is not Limited thereto. As described above, the copper salt or the hydrate thereof may be cupric nitrate trihydrate (Cu(NO₃)₂.3H₂O), such that copper sulfate, copper oxide (II), or the like generally used in producing the copper precursor may not be used, to thereby produce the copper precursor without an intermediate.

More specifically, in the general method of producing the copper hydroxide precipitate by adding sodium hydroxide to an aqueous copper sulfate solution, since the copper precursor is produced after an intermediate such as basic copper sulfate (CuSO₄.3Cu(OH)₂) being generated, a process of generating the intermediate is required.

However, according to the embodiment of the present invention, since the process of generating the intermediate not required to thereby simplify the process of producing the copper precursor, the copper precursor may be mass-produced.

The preparing of the aqueous solution including a copper salt or a hydrate thereof may be performed by dissolving, for example, the copper salt or the hydrate thereof in water at room temperature, but it is not limited thereto.

Next, the mixture may be prepared by mixing urea (CO(NH₂)₂) with the aqueous solution.

The preparing of the mixture may be performed at room temperature, but is not limited thereto.

In addition, the preparing of the mixture may be performed by mixing 12 to 200 parts by weight of urea (CO(NH₂)₂) with the aqueous solution based on 100 parts by weight of the copper salt or the hydrate thereof.

The mixture may be prepared by mixing 12 to 200 parts by weight of urea (CO(NH₂)₂) with the aqueous solution based on 100 parts by weight of the copper salt or the hydrate thereof, such that the copper precursor may be mass-produced at a relatively low temperature.

In the case in which the content of urea (CO(NH₂)₂) is less than 12 parts by weight based on 100 parts by weight of the copper salt or the hydrate thereof, the content of urea is relatively significantly low, and thus, the copper precursor may not be sufficiently synthesized.

Meanwhile, in the case in which the content of urea (CO(NH₂)₂) is more than 200 parts by weight based on 100 parts by weight of the copper salt or the hydrate thereof, the content of urea is relatively significantly high, and thus, the copper precursor may not be synthesized and the content of organic material may increase.

Next, the method of producing the copper precursor according to the embodiment of the present invention may include synthesizing the copper precursor by heating the mixture at a temperature of 100 to 120° C.

In the synthesizing of the copper precursor as described above, since the reaction is performed at a relatively low temperature of 100 to 120° C., the copper precursor may be mass-produced as compared to the general process of producing the copper precursor.

More specifically, in the general process of producing the copper precursor, since the synthesizing process is performed at a relatively high temperature of 160 to 200° C., mass production may be difficult.

However, according to the embodiment of the present invention, the copper precursor may be synthesized at a relatively low temperature to thereby allow for mass production thereof as described above, as compared to the general method of producing the copper precursor.

The method of producing the copper precursor according to the embodiment of the present invention may further include drying the copper precursor at 60 to 80° C., after the synthesizing of the copper precursor.

The copper precursor according to another embodiment of the present invention may have a carbon (C) content of 0.3 wt % as a detection reference value, or less.

In addition, the copper precursor may be Cu₂(NO₃) (OH)₃.

It may be appreciated that the copper precursor synthesized by the method of producing the copper precursor according to the embodiment of the present invention may have a carbon (C) content of 0.3 wt % as a detection reference value, or less, as described above, such that the organic content thereof is significantly lower as compared to the copper precursor produced by the general production method.

Therefore, according to the embodiment of the present invention, the copper precursor having a relatively low organic material content and excellent quality may be mass-produced.

The copper precursor according to another embodiment of the present invention is produced by the method of producing the copper precursor according to the embodiment of the present invention as described above, and may be produced by mixing urea (CO(NH₂)₂) with the aqueous solution including the copper salt or the hydrate thereof and have a carbon (C) content of 0.3 wt % as a detection reference value, or less.

That is, the copper precursor according to another embodiment of the present invention may have a relatively low organic material content to thereby allow for excellent quality thereof, as compared to the copper precursor produced by the general production method.

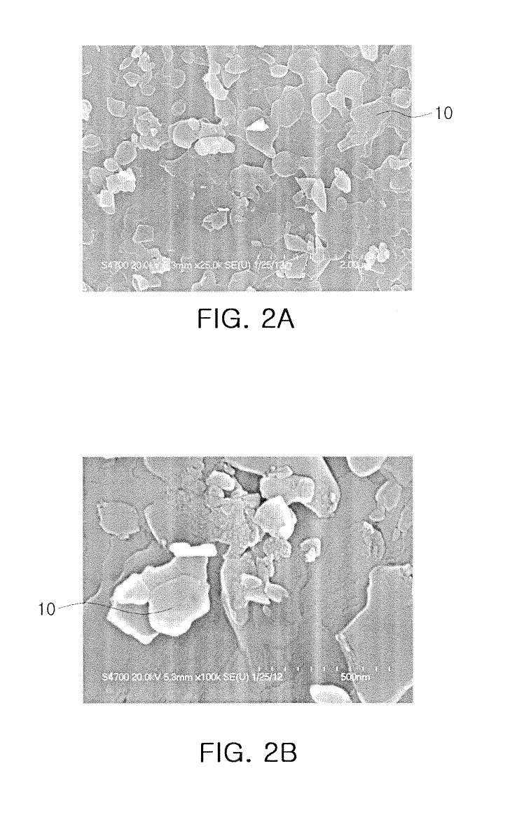

FIGS. 2A and 2B are scanning electron microscope (SEM) images of the copper precursor 10 according to the embodiment of the present invention, which show the copper precursor 10 produced by the method of producing the copper precursor according to the embodiment of the present invention, for reference.

More specifically, FIG. 2A is a 25 times enlarged photograph of the copper precursor 10 produced by the method of producing the copper precursor according to the embodiment of the present invention, and FIG. 2B is a 100 times enlarged photograph thereof.

Since additional characteristics of the copper precursor according to another embodiment of the present invention are similar to those as described in the method of producing the copper precursor according to the embodiment of the present invention as described above, descriptions thereof will be omitted.

The copper precursor produced by the method of producing the copper precursor according to the embodiment of the present invention may be used to produce copper powder.

The producing of the copper powder may be generally performed by a wet reducing process, but is not specifically limited thereto.

More specifically, in the producing of the copper powder, the copper powder may be produced by preparing a reaction solution including the copper precursor produced according to the embodiment of the present invention, heating the reaction solution at a temperature of 220 to 350° C., to thereby pyrolyze the copper precursor material.

At the time of producing copper nano particles through pyrolysis, the copper precursor material may be heated at a temperature of 220 to 350° C., to thereby synthesize the copper nano particles.

In another method, amines may be added in the reaction solution including the copper precursor and the temperature of the reaction solution may be increased to 210 to 350° C., to thereby obtain the copper nano particles.

The amines are aliphatic amines, and may include a primary aliphatic amine having 3 to 18 carbon numbers.

More specifically, examples of the amine may include oleylamine, dodecylamine, hexadecylamine, and the like, but are not limited thereto.

Meanwhile, the aliphatic amine may be added in the molar ratio of 0.5 to 10 based on the copper precursor material.

The temperature of the reaction solution obtained by adding the aliphatic amines thereinto may be increased to 210 to 350° C., to thereby obtain the copper nano particles.

The produced copper nano particles may be obtained as a powder through general filtering, washing, and drying.

An example of the solvent usable in this case is not particularly limited. For example, methanol, acetone, toluene, or a mixture thereof may be input thereinto, and subsequently, centrifugation is performed, to thereby obtain the copper powder.

Hereafter, although the present invention will be described in detail with reference to embodiments, it is not limited thereto.

### EXAMPLES

1 to 16 kg of Cupric nitrate trihydrate (Cu(NO₃)₂.3H₂O), a nitrate salt of copper, was dissolved in water at room temperature to prepare an aqueous solution.

Next, 2 to 10 kg of urea (CO(NH₂)₂) was mixed with the aqueous solution in which cupric nitrate trihydrate (Cu(NO₃)₂.3H₂O) was dissolved, at room temperature.

The mixed solution was heated to 100 to 120° C., to synthesize Cu₂(NO₃) (OH)₃, the copper precursor.

### Comparative Example

1 to 16 kg of copper sulfate pentahydrate ((CuSO₄).5H₂O), the sulfate salt of the copper, was dissolved in water at room temperature to prepare an aqueous solution.

Next, 2 to 10 kg of sodium hydroxide (NaOH) was mixed with the aqueous solution in which copper sulfate pentahydrate ((CuSO₄).5H₂O) was dissolved, at room temperature to synthesize copper hydroxide (Cu(OH)₂) the copper precursor.

Table 1 below shows values of wt % that were measured for each element of the copper precursor produced by the method of producing the copper precursor according to the embodiment of the present invention and copper hydroxide (Cu(OH)₂) as a comparative example, and Table 2 below shows theoretical values for each element of Cu₂(NO₃) (OH)₃.

TABLE 1
Unit: wt %

| | C | H | N | S | O |
|---|---|---|---|---|---|
| Copper | <0.3 | 1.2 | 6.0 | <0.3 | 38.5 |
| precursor | | | | | |
| Copper | | | | | |
| hydroxide | 0.5 | 2.0 | <0.3 | <0.3 | 31.2 |
| (Cu(OH)₂) | | | | | |

TABLE 2

Cu₂(NO₃)(OH)₃

| | Cu | H | N | O |
|---|---|---|---|---|
| mol | 2 | 3 | 1 | 6 |
| weight | 126 | 3 | 14 | 96 |
| wt % | 53 | 1.3 | 5.9 | 40 |

Referring to Table 1 above, it may be appreciated that, in the values of wt % for each element of the copper precursor produced according to the embodiment of the present invention, the hydrogen (H) content was 1.2 wt %, the nitrogen (N) content was 6.0 wt %, and the oxygen (O) content was 28.5 wt %.

Meanwhile, it may be appreciated that, in the values of wt % for each element of the copper hydroxide (Cu(OH)₂), the copper precursor according to the comparative example, the hydrogen (H) content was 2.0 wt %, the nitrogen (N) content was 0.3 wt % or less, and the oxygen (O) content was 31.2 wt %.

Meanwhile, it may be appreciated that the theoretical values of wt % for each element of Cu₂(NO₃) (OH)₃ according to Table 2 above were nearly equal to the values of wt % for each element of the copper precursor according to the example of the present invention.

Therefore, referring to Tables 1 and 2 above, may be appreciated that the copper precursor synthesized by the method of producing the copper precursor according to the embodiment of the present invention was Cu₂(NO₃) (OH)₃.

As described above, it may be appreciated that the copper precursor synthesized by the method of producing the copper precursor according to the embodiment of the present invention had a carbon (C) content of 0.3 wt % as a detection reference value, or less, and thus, the organic content thereof was significantly lower as compared to the copper precursor produced by the general production method.

Meanwhile, it may be appreciated that the carbon (C) content of copper hydroxide (Cu(OH)₂), the copper precursor according to the comparative example, was 0.5 wt %, and thus, the organic material content thereof was high.

Therefore, according to the embodiment of the present invention, the copper precursor having a relatively low organic material content and excellent quality may be mass-produced.

The synthesis rate of cupric nitrate trihydrate (Cu(NO₃)₂.3H₂O) to urea (CO(NH₂)₂), the production amount of the copper precursor, and the ratio of an input amount of the raw material. vs. production amount of the copper precursor were measured for comparison of the production amount of the copper precursor (Cu₂(NO₃) (OH)₃) according to the example above, and then the measurement results were tabulated in Table 3 below.

TABLE 3

| | | | Production | | |
|---|---|---|---|---|---|
| Input amount (Kg) | | | amount (Kg) | Comparison | |
| Cupric nitrate | | | Copper | Production | |
| trihydrate | Urea | Synthesis | precursor | amount/input | |
| (Cu(NO₃)₂•3H₂O) | (CO(NH₂)₂) | rate | (Cu₂(NO₃)(OH)₃) | amount | Note |
| 16 | 2 | 8:1 | 0.8 | 0.0444 | |
| 16 | 4 | 4:1 | 15.9 | 0.7950 | |
| 10 | 10 | 1:1 | 10.1 | 0.5050 | |
| 5 | 10 | 0.5:1 | 1.1 | 0.0733 | |
| 1 | 10 | 0.1:1 | 0.1 | 0.0091 | Not |
| | | | | | synthesized |

Referring to Table 3 above, the copper precursor (Cu₂(NO₃) (OH)₃) according to the inventive example may be synthesized by mixing 12 to 200 parts by weight of urea (CO(NH₂)₂) with the aqueous solution based on 100 parts by weight of cupric nitrate trihydrate (Cu(NO₃)₂.3H₂O). In the case in which it is outside of the numerical range, the copper precursor was not synthesized.

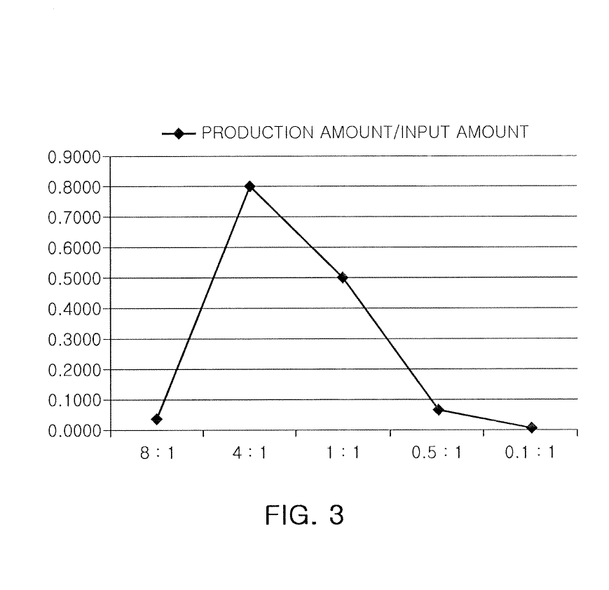

FIG. 3 is a graph illustrating the input amount vs. production amount according to the embodiment of the present invention.

Referring to Table 3 above and FIG. 3, the ratio of a production amount of the copper precursor (Cu₂(NO₃) (OH)₃), based on an input amount of cupric nitrate trihydrate (Cu(NO₃)₂.3H₂O) and urea (CO(NH₂)₂) may be appreciated.

According to the embodiment of the present invention, the copper precursor may be produced without using the intermediate in the process of producing the copper precursor.

In addition, according to the embodiment of the present invention, since the reaction is performed at a relatively low temperature of around 100 to 120° C., at the time of synthesizing of the copper precursor, the synthesizing may be performed at a temperature relatively lower than 160 to 200° C., used at the time of the existing reaction process.

Therefore, the copper precursor may be mass-produced.

In addition, according to the embodiment of the present invention, unlike the process of the related art, since a fatty acid is not used during the process, the synthesized copper precursor may have a relatively low organic material content to thereby produce a copper precursor having excellent quality.

As set forth above, according to the embodiment of the present invention, the copper precursor may be produced without using the intermediate in the process of producing the copper precursor.

In addition, according to the embodiment of the present invention, since the reaction is performed at a relatively low temperature around 100 to 120° C., at the time of synthesizing the copper precursor, the synthesizing may be achieved at temperature relatively lower than 160 to 200° C., at the time of the existing reaction process. Therefore, the copper precursor may be mass-produced.

In addition, according to the embodiment of the present invention, unlike the process of the related art, since fatty acid or the like is not used in the process, the synthesized copper precursor may have a relatively low organic material content to thereby produce the copper precursor having excellent quality.

While the present invention has been shown and described in connection with the embodiments, it will be apparent to those skilled in the art that modifications and variations may be made without departing from the spirit and scope of the invention as defined by the appended claims.

What is claimed is:

1. A method of producing a copper precursor, the method comprising:
preparing an aqueous solution including a copper salt or a hydrate thereof;
preparing a mixture by mixing urea (CO(NH₂)₂) with the aqueous solution; and
synthesizing the copper precursor by heating the mixture at a temperature of 100 to 120° C.

2. The method of claim 1, wherein the copper salt or the hydrate thereof is cupric nitrate trihydrate (Cu(NO₃)₂.3H₂O).

3. The method of claim 1, wherein the preparing of the aqueous solution is performed by dissolving the copper salt or the hydrate thereof in water at room temperature.

4. The method of claim 1, wherein the preparing of the mixture is performed at the room temperature.

5. The method of claim 1, further comprising, after the synthesizing of the copper precursor, drying the copper precursor at 60 to 80° C.

6. The method of claim 1, wherein the copper precursor is Cu₂(NO₃) (OH)₃.

7. The method of claim 1, wherein the copper precursor has a carbon (C) content of 0.3 wt % as a detection reference value, or less.

8. The method of claim 1, wherein the preparing of the mixture is performed by mixing 12 to 200 parts by weight of urea (CO(NH₂)₂) with the aqueous solution based on 100 parts by weight of the copper salt or the hydrate thereof.

9. A copper precursor produced by mixing urea (CO(NH₂)₂) with an aqueous solution including a copper salt or a hydrate thereof, the copper precursor having a carbon (C) content of 0.3 wt % as a detection reference value, or less.

10. The copper precursor of claim 9, wherein the copper salt or the hydrate thereof is cupric nitrate trihydrate (Cu(NO₃)₂.3H₂O).

11. The copper precursor of claim 9, wherein the copper precursor is Cu₂(NO₃) (OH)₃.
